(19) United States
(12) Patent Application Publication
(10) Pub. No.: US 2021/0286807 A1
(43) Pub. Date: Sep. 16, 2021

(54) GATEWAY DEVICE AND NON-TRANSITORY COMPUTER-READABLE MEDIUM

(71) Applicants: Hiroki SAKAMOTO, Aichi (JP); Kenshin OH, Aichi (JP)

(72) Inventors: Hiroki SAKAMOTO, Aichi (JP); Kenshin OH, Aichi (JP)

(73) Assignee: NIDEC MOBILITY CORPORATION, Aichi (JP)

(21) Appl. No.: 17/198,245

(22) Filed: Mar. 11, 2021

(30) Foreign Application Priority Data
Mar. 12, 2020 (JP) 2020-043194
Nov. 20, 2020 (JP) 2020-193617

(51) Int. Cl. G06F 16/245; G06F 16/22

(52) U.S. Cl. CPC G06F 16/245; H04L 67/12; G06F 16/2228

(57) ABSTRACT

An in-vehicle gateway device includes a CPU and a memory, and the CPU includes an ID acquisitor configured to acquire a data ID associated with data to be received from an in-vehicle network, and a decider configured to derive a plurality of indices from the data ID, specify a reference destination in a reference table stored in the memory based on a plurality of derived indices, and decide a processing content related to data associated with the data ID based on information stored in a specified reference destination.

### CROSS-REFERENCE TO RELATED APPLICATION

This application is based on Japanese Patent Application No. 2020-43194 filed with the Japan Patent Office on Mar. 12, 2020 and Japanese Patent Application No. 2020-193617 filed with the Japan Patent Office on Nov. 20, 2020, the entire contents of which are incorporated herein by reference.

### FIELD

The present invention relates to an in-vehicle gateway device and a data structure.

### BACKGROUND

In in-vehicle network communication, when data is transferred between in-vehicle devices, it is sometimes decided whether or not data transfer is permitted. In this case, a determination list indicating whether or not to permit data transfer for each data ID is stored in a program, and when receiving in-vehicle network data, whether or not the transfer of the in-vehicle network data should be permitted is determined with reference to the determination list from the in-vehicle network data ID. Alternatively, detection of an abnormality of the in-vehicle network data is performed from the determination list.

Various techniques have been proposed for shortening the decision time in the above-described data processing. For example, a technique for shortening the search time of the determination list by labeling the received data and analyzing the label is disclosed (Japanese Patent Application Laid-Open No. 2019-213081).

However, the above-described technique requires a configuration for labeling the received data.

### SUMMARY

In view of the above problem, an object of an aspect of the present invention is to provide a technique capable of quickly deciding processing for data received from an in-vehicle network within a certain time regardless of the data to be received, while suppressing the complication of the configuration.

In order to solve the problem described above, a gateway device according to an aspect of the present invention includes a controller and a storage, and the controller includes an ID acquisitor configured to acquire a data ID associated with data to be received from an in-vehicle network, and a decider configured to derive a plurality of indices from the data ID, specify a reference destination in a reference table stored in the storage based on a plurality of derived indices, and decide a processing content related to data associated with the data ID based on information stored in a specified reference destination.

According to the above configuration, with regard to data to be received from the in-vehicle network, a reference destination can be quickly decided from the reference table using the plurality of indices derived from the data ID of the data, and the processing content for the data can be decided based on information stored in the reference destination. Moreover, the time required to decision on the processing content becomes constant regardless of the registration position of the data ID.

In the gateway device according to the aspect described above, the decider may decide whether or not to transfer data associated with the data ID based on information stored in the specified reference destination.

According to the configuration described above, the registration position of the corresponding data can be calculated quickly and within a certain time regardless of the data to be received by referring to a plurality of indices as compared with the case of searching a one-dimensional determination list.

In the gateway device according to the aspect described above, the decider may decide a data length of data associated with the data ID based on information stored in the specified reference destination, and decide whether or not to transfer the data according to the decided data length.

According to the configuration described above, it is possible to quickly specify the processing content for the data based on the data length of the data.

In the gateway device according to the aspect described above, the decider may derive at least a first index and a second index as the plurality of indices, specify any of a plurality of tables included in the reference table based on the first index, specify one or a plurality of values indicated by the second index from each value stored in a specified table, and decide a processing content to be executed based on a specified value.

According to the configuration described above, in the processing of deciding the processing content for data, it is possible to quickly decide the processing content for the data from a two-dimensional table by using a plurality of indices.

In the gateway device according to the aspect described above, the decider may set a quotient and a remainder obtained by dividing the data ID by a predetermined constant as the first index and the second index, respectively.

According to the configuration described above, a plurality of indices can be derived from the data ID by a simple calculation.

In the gateway device according to the aspect described above, the predetermined constant may match an address allocation unit in the storage.

According to the configuration described above, it becomes possible to access the reference destination in the storage by using the quotient and the remainder obtained from the data ID as they are without converting them. Accordingly, it is possible to derive a plurality of indices from the data ID by a simple calculation, and quickly decide the processing content for the data from the two-dimensional table.

In the gateway device according to the aspect described above, the control decider may include a reception time information recorder configured to record reception time information indicating a time at which data is received, and a reception cycle abnormality determiner, and when information stored in a reference destination specified using a data ID associated with received data indicates necessity of cycle monitoring for the data, the reception time information recorder may record reception time information of the data having been received, and the reception cycle abnormality determiner may determine presence or absence of an abnormality of reception cycle of the data based on past reception time information and current reception time information recorded by the reception time information recorder.

According to the configuration described above, it is possible to decide the presence or absence of abnormality in the reception cycle of the data after determining the necessity of cycle monitoring for the data by referring to a table, and therefore, it is possible to further secure the safety of the network.

In order to solve the above problem, a data structure according to an aspect of the present invention is a data structure of data referred to by an in-vehicle gateway device, and includes a plurality of tables storing each value indicating a processing content, and the gateway device derives a plurality of indices including a first index and a second index from a data ID associated with the data, specifies any of the plurality of tables based on the first index, specifies a value indicated by the second index from each value stored in a specified table, and decides a processing content to be executed based on a specified value.

According to the configuration described above, it is possible to achieve the same effects as those of the gateway device described above.

According to an aspect of the present invention, it is possible to quickly decide processing for data received from an in-vehicle network within a certain time regardless of the data to be received, while suppressing the complication of the configuration.

### BRIEF DESCRIPTION OF THE DRAWINGS

FIG. 1 is a block diagram illustrating an outline of a hardware configuration of a vehicle on which a gateway device of the embodiment is mounted;

FIG. 2 is a block diagram showing an example of a configuration of a CPU used in the gateway device of a first embodiment;

FIG. 3 is a diagram showing an example of a determination bitmap used in the gateway device of the first embodiment;

FIG. 4 is a diagram showing another example of a determination bitmap used in the gateway device of the first embodiment;

FIG. 5 is a flowchart showing a flow of processing in the gateway device of the first embodiment;

FIG. 6 is a diagram showing an example of a determination list used in a conventional gateway device;

FIG. 7 is a block diagram showing an example of a configuration of a CPU used in a gateway device of a second embodiment;

FIG. 8 is a diagram schematically showing an example of a cycle monitoring determination bitmap and cycle monitoring management information used in the gateway device of the second embodiment;

FIG. 9 is a flowchart showing a flow of processing in the gateway device of the second embodiment;

FIG. 10 is a table showing an example of cycle monitoring management information in the gateway device of the second embodiment; and

FIG. 11 is a table showing an example the cycle monitoring management information shown in FIG. 10 having been updated.

### DETAILED DESCRIPTION

Embodiments of the disclosure will be described with reference to the drawings. In the drawings, the identical or equivalent component is designated by the identical numeral. In embodiments of the disclosure, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

Embodiments according to an aspect of the present invention (hereinafter also referred to as “embodiments”) will be described below with reference to the drawings.

<Configuration of Vehicle 1>

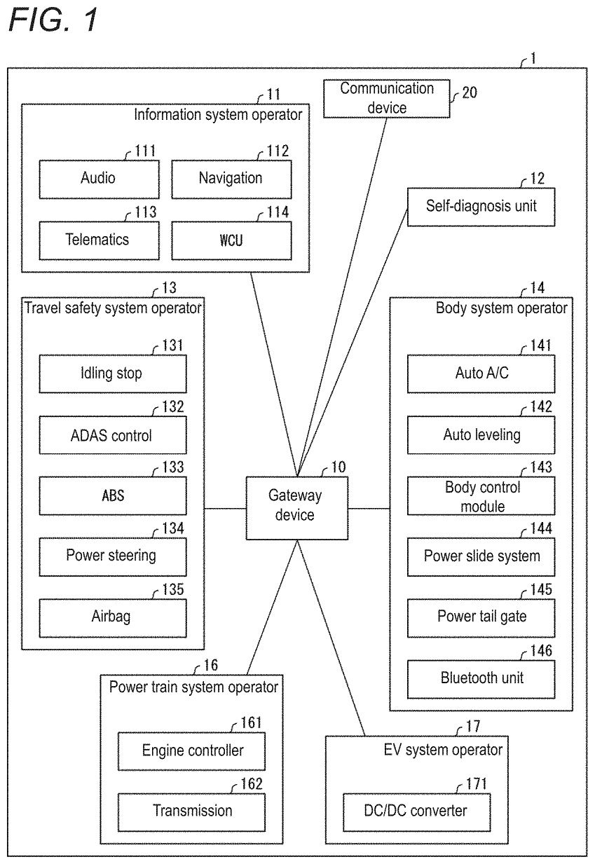

First, the configuration of a vehicle 1 on which a gateway device 10 of the embodiment is mounted will be described. FIG. 1 is a block diagram illustrating the hardware configuration of the vehicle 1 on which the gateway device 10 of the embodiment is mounted. The vehicle 1 shown in FIG. 1 includes the gateway device 10, an information system operator 11 connected to the gateway device 10, a self-diagnosis unit 12, a travel safety system operator 13, a body system operator 14, a power train system operator 16, an EV system operator 17, and a communication device 20.

The gateway device 10 can communicate with an external device via the communication device 20. Devices in each operator form a network together with another device in the same operator, and the devices in the same operator can communicate directly with each other. The gateway device 10 is connected to these networks, and devices belonging to different operators can communicate with each other via the gateway device 10.

As shown in FIG. 1, each operator includes a plurality of devices.

The information system operator 11 includes a device that provides a user with information and a service. As an example, the information system operator 11 includes audio 111, navigation 112, telematics 113, and a wireless charger unit (WCU, a unit that wirelessly charges a device to be charged such as a smart phone when the device to be charged is placed) 114. By operating these devices, the user can acquire information regarding situations of the vehicle and its surroundings and obtain various services.

The self-diagnosis unit 12 is, for example, OBDII, and includes a function of detecting the state of the own vehicle.

The travel safety system operator 13 includes a device for supporting safe driving. For example, the travel safety system operator 13 includes idling stop 131, advanced driver-assistance system (ADAS) control 132, an anti-lock braking system (ABS) 133, power steering 134, and an airbag 135 or the like.

The body system operator 14 includes an auto A/C 141, auto leveling 142, a body control module 143, a power slide system 144, a power tail gate 145, and a Bluetooth (Registered trademark of Bluetooth SIG, Inc.) unit 146 or the like. The vehicle 1 can communicate with a portable terminal or the like via the Bluetooth unit 146.

The power train system operator 16 includes a device for transmitting rotational energy generated in an engine of the vehicle 1 to drive wheels. For example, the power train system operator 16 includes an engine controller 161 and a transmission 162 or the like.

The EV system operator 17 includes a DC/DC converter or the like.

### First Embodiment

<Configuration of Gateway Device 10>

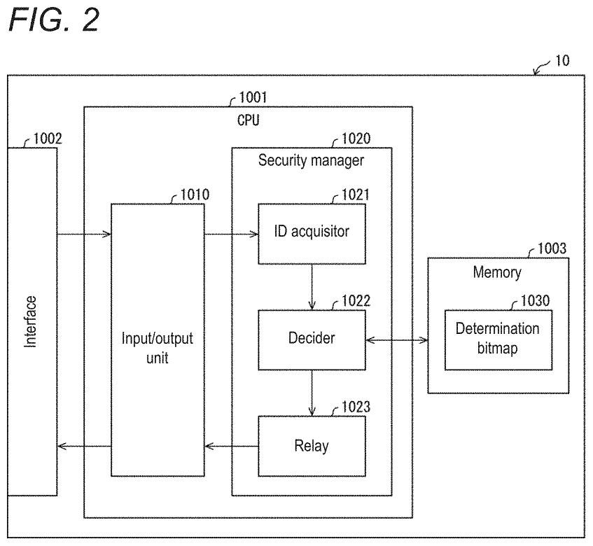

Next, the configuration example of the gateway device 10 in the first embodiment will be described with reference to FIG. 2. FIG. 2 is a block diagram showing an example of the functional configuration of the gateway device 10 in the first embodiment. As shown in FIG. 2, the gateway device 10 includes a CPU (“controller” in the claims) 1001, an interface 1002, and a memory (“storage” in the claims) 1003. The memory 1003 is, for example, a flash memory. The memory 1003 stores a determination bitmap 1030 in which a data ID and a processing content are associated with each other.

The CPU 1001 includes an input/output unit 1010 and a security manager 1020.

The interface 1002 connects the gateway device 10 with another in-vehicle device.

Data from another in-vehicle device are input to the security manager 1020 via the interface 1002 and the input/output unit 1010 of the CPU 1001. The security manager 1020 decides a processing content for received data. The processing content includes abnormality detection of data or determination as to whether or not to transfer data to another in-vehicle device.

As shown in FIG. 2, the security manager 1020 includes an ID acquisitor 1021, a decider 1022, and a relay 1023.

The ID acquisitor 1021 acquires a data ID associated with data received from an in-vehicle network. Acquired data ID is transmitted to the decider 1022.

The decider 1022 derives a plurality of indices from the data ID acquired by the ID acquisitor 1021, and refers to the plurality of derived indices to decide a processing content related to data associated with the data ID. In other words, the decider 1022 specifies a reference destination in the determination bitmap 1030 (reference table) stored in the memory 1003 based on the plurality of indices derived from the data ID acquired by the ID acquisitor 1021. Then, the decider 1022 decides the processing content related to the data associated with the data ID based on the information stored in the specified reference destination. At this time, the decider 1022 decides the processing content for the data with reference to the determination bitmap 1030. For example, the decider 1022 determines whether to instruct the relay 1023 to transfer the received data to another in-vehicle device or whether to discard the data without transferring. A method of deriving a plurality of indices will be described later.

Upon receiving an instruction from the decider 1022, the relay 1023 transfers the data received by the gateway device 10 or discards the data without transferring.

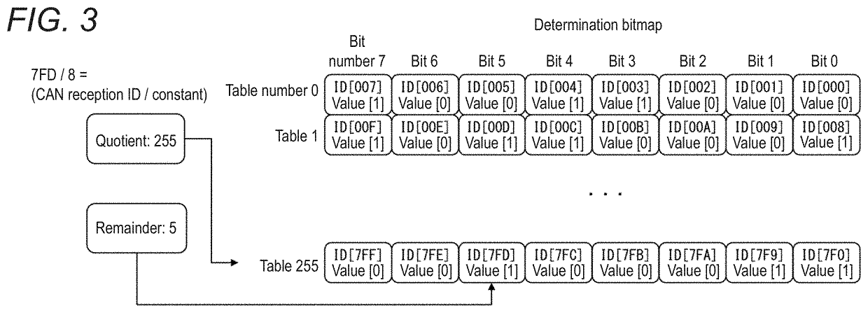

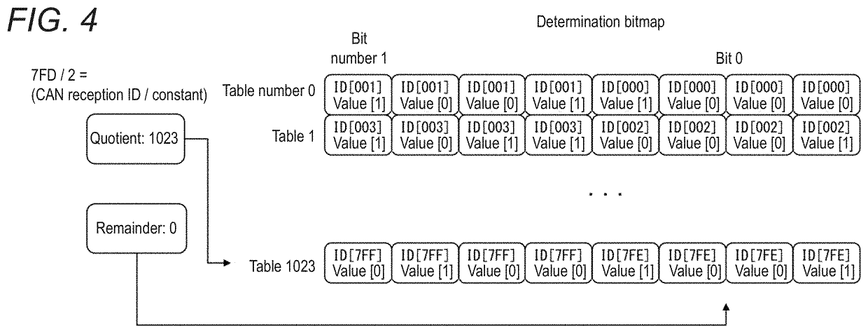

Details of the determination bitmap 1030 will be described later with reference to FIGS. 3 and 4.

### Comparative Example

Prior to description of a determination list to be referred to by the gateway device according to the present invention when filtering data, a data determination list in a conventional comparative example will be described.

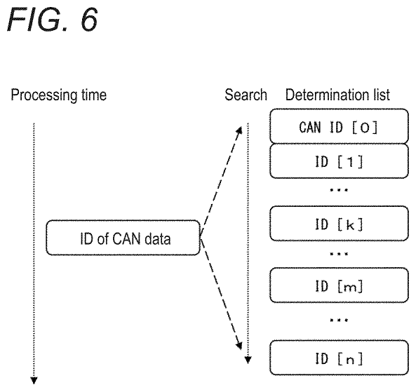

In a conventional gateway device, for example, as shown in FIG. 6, regarding controller area network (CAN) data as an example of data received from an in-vehicle network, a one-dimensional determination list of (n+1) data from CAN data IDs [0] to [n] is created, and information regarding the processing content for each CAN data is stored in each row of the determination list. For example, as data processing, whether to permit transfer of the data or whether to prohibit transfer of the data is stored. Alternatively, determination whether or not the data has an abnormality is stored. When receiving CAN data, a corresponding data ID is searched from the determination list, the processing content stored in the searched position is read, and the processing of the CAN data is decided. Alternatively, whether or not the data has an abnormality is detected.

However, in a case where using the one-dimensional determination list as shown in FIG. 6, if the position in the determination list corresponding to the CAN data ID is searched, the search takes time in proportion to the number of registrations of the determination list. The search time varies greatly depending on the registration position of the data in the determination list.

According to the above technique, in CAN communication filtering, search of the determination list takes time in proportion to the number of registrations of the determination list, and as a result, the transfer of CAN data also takes time. When the transfer speed of CAN data slows down, the communication amount of data that can be transferred decreases. Therefore, the network becomes vulnerable to DOS attacks, and CAN data IDs cannot sometimes be transferred.

In view of the above problem, in CAN communication filtering, the gateway device according to the present invention bit-patterns the determination list, derives two or more indices from the CAN data ID, and rapidly calculates the position of the CAN data ID in the determination list from the two or more indices thus derived. The determination list to be referred to by the gateway device according to the present invention when filtering data will be described below.

<Determination Bitmap Example 1>

FIG. 3 shows an example of the determination bitmap 1030, which is an example of the determination list used in the embodiment. The determination bitmap 1030 is a table including 8 columns in the horizontal direction from bit number 0 to bit number 7 and 256 rows in the vertical direction from table number 0 to table number 255, and storing a total of 2048 data IDs together with the processing content for data associated with each data ID. The processing content related to data associated with each data ID is stored in each position of the determination bitmap 1030. The processing content includes whether to permit or prohibit transfer of each data and detection of abnormal data.

For example, as data processing, a value [1] is stored when permitting transfer of the data, and a value [0] is stored when prohibiting transfer of the data. Alternatively, the value [1] may be stored when the data has no abnormality, and the value [0] may be stored when the data has an abnormality. When CAN data is received, the corresponding data ID is searched from the determination bitmap 1030, and the value [0] or [1] stored in the searched position is read to decide the processing of the CAN data. Alternatively, whether or not the data has an abnormality may be decided.

In the in-vehicle gateway device 10 of the embodiment, the decider 1022 derives a plurality of indices from the data ID, and refers to the plurality of indices to decide whether or not to transfer the data associated with the data ID. In other words, in the in-vehicle gateway device 10 of the embodiment, the decider 1022 derives a plurality of indices from the data ID, specifies a reference destination in the determination bitmap 1030 stored in the memory 1003 based on the derived indices, and decides whether or not to transfer data associated with the data ID based on the information stored in the reference destination.

The number of derived indices is not particularly limited, but in the embodiment, two indices are derived.

For example, the decider 1022 may derive a first index and a second index as a plurality of indices, specify any of the plurality of tables included in the determination bitmap 1030 based on the first index, specify one or a plurality of values indicated by the second index from each value stored in a specified table, and decide a processing content to be executed based on the specified value.

The method of deriving a plurality of indices from data ID is also not particularly limited.

For example, the decider 1022 may set the quotient and the remainder obtained by dividing the data ID as the first index and the second index, respectively.

With reference to the determination bitmap shown in FIG. 3, the derivation of index and the decision of the processing content for data based on the derived index will be specifically described below.

In the embodiment, the decider 1022 divides the received CAN data ID by a predetermined constant (e.g., 8). The quotient obtained as a result of division is set as a first index and the remainder obtained as a result of division is set as a second index.

As an example, assume that as a result of dividing the CAN data ID: 7FD by a predetermined constant 8, a quotient 255 and a remainder 5 are obtained. With reference to the quotient 255, which is the first index, the decider 1022 specifies the table of the table number 255 from a plurality of tables (table number 0 to table number 255) included in the determination bitmap shown in FIG. 3. With reference to the remainder 5, which is the second index, the decider 1022 specifies the bit of the bit number 5 from the table of the table number 255.

Thus, the position in the determination bitmap 1030 corresponding to the CAN data ID: 7FD in the determination bitmap, i.e., the position of the table number 255 and the bit number 5 is specified. The value [1] is stored in the specified position. Therefore, the decider 1022 can judge that the data corresponding to the CAN data ID: 7FD is permitted to be transferred. In this case, the decider 1022 instructs the relay 1023 to transfer the data to a predetermined in-vehicle device.

As described above, in the gateway device 10 of the embodiment, the decider 1022 uses an algorithm to divide the CAN data ID of the received data by a predetermined constant, and specify a reference destination in the determination bitmap from the obtained quotient and remainder. Here, in the embodiment, a predetermined constant (8 in the above example) for dividing the received CAN data ID can be defined according to the physical configuration of the storage area in the memory 1003. Therefore, in the embodiment, it becomes possible to access the reference destination in the memory 1003 using the quotient and the remainder obtained from the data ID as they are without conversion. Therefore, compared with the case where the stored data are searched in order from the top, it is possible to quickly decide the processing content indicated by the information of the reference destination within a certain time regardless of the data to be received. Therefore, it is possible to shorten the data transfer time. As a result, it is possible to increase the communicable data amount, and it is possible to maintain the transfer performance even if a DOS attack is made, thereby leading to an improvement in security.

<Additional Notes on Physical Configuration of Memory>

The above-described “access to the reference destination in the memory 1003 without conversion” will be specifically described as follows.

In the embodiment, the physical configuration of the memory 1003 may be, for example, a configuration in which an address is allocated for each predetermined number of bits. Here, the predetermined number of bits includes, for example, 8 bits and 16 bits, but this does not limit the embodiment.

As an example, consider a case of use of the memory 1003 to which an address is allocated every 8 bits. In other words, consider a case of use of the memory 1003 in which the address allocation unit is 8 bits. In this case, if a predetermined constant for dividing the CAN data ID is set to 8 so as to be consistent with the allocation of the address in the memory, the table number that is the quotient and the address in the memory 1003 will match. Therefore, using the quotient derived by the decider 1022, it becomes possible to access the memory 1003 without converting the derived quotient. It is possible to decide, by multiplication/division derived by the decider 1022, as to which bit of the 8 bits stored in the address to refer to.

Thus, according to the gateway device 10 of the embodiment, it is possible to quickly decide the processing content indicated by the information of the reference destination in the reference table stored in the memory 1003 within a certain time regardless of the data to be received.

The above description has given an example in which the memory 1003 has a configuration in which an address is allocated every 8 bits, but more generally, the memory 1003 can have a configuration in which an address is allocated every N bits. In other words, it is possible to use the memory 1003 whose address allocation unit is N bits. In this case, if a predetermined constant for dividing the CAN data ID is set to N, the table number that is the quotient and the address in the memory 1003 will match. Therefore, even such a configuration can achieve the same effects as those described above.

<Determination Bitmap Example 2>

In the gateway device 10 of the present invention, the decider 1022 may decide a data length of the data associated with the data ID based on a plurality of indices, and decide whether or not to transfer the data according to the decided data length.

Such a specific example will be described with reference to FIG. 4.

FIG. 4 shows another example of the determination bitmap in the present invention. In the determination bitmap shown in FIG. 4, the data length of the data corresponding to the CAN data ID is stored using 4 bits. The determination bitmap of this example is a table including 8 columns (4 columns each) in the horizontal direction with bit number 0 and bit number 1, and 1024 rows in the vertical direction with table number 0 to table number 1023, and storing a total of 2048 data IDs together with processing content for data associated with each data ID. With [4 horizontal bits×1 vertical table] as one unit, the data length of one corresponding data is stored. That is, the data length of the data associated with each data ID is stored using 4 bits.

For example, in this example, the data length of [1000] and [8] bytes in decimal number may be set as conditions for permitting data transfer. In this case, for example, the data corresponding to the CAN data ID at the position of the table number 1023 and the bit number 1 can be read as the data length of [0100] and, in the decimal number, as the data length of [4] bytes. Therefore, this data is not permitted to be transferred. The data corresponding to the CAN data ID stored in the position of the table number 1 and the bit number 1 can be read as the data length of [1011] and, in the decimal number, as the data length of [11] bytes. Therefore, this data is also not permitted to be transferred.

Here, assume that the data having the CAN data ID: 7FE is divided by the constant 2 to obtain a quotient of 1023 and a remainder of 0. With reference to the quotient 1023, which is the first index, the decider 1022 specifies the table of the table number 1023 from the table number 0 to table number 1023, which are the plurality of tables included in the determination bitmap shown in FIG. 4. With reference to the remainder 0, which is the second index, the decider 1022 specifies the bit position of the bit number 0 from the table of the table number 1023. In the position of the table number 1023 and the bit number 0 of the determination bitmap, a value [1000] is stored, and the data length can be read as [8] bytes in the decimal number. Therefore, the decider 1022 judges that the data corresponding to the CAN data ID: 7FE is permitted to be transferred.

As described above, in the gateway device 10 of this example, the decider 1022 uses an algorithm to divide the CAN data ID of the received data by a certain constant, and can quickly decide the processing content indicated by the information of the reference destination from the obtained quotient and remainder. Therefore, it is possible to quickly specify the data length of the corresponding data, and it is also possible to quickly decide the processing content based on the data length. Therefore, it is possible to shorten the data transfer time. Since it is usually unthinkable that a malicious data transferor falsifies the data length of data, it is effective to detect abnormal data based on the data length.

Other than the above, the gateway device of the present invention may store information regarding the content of data in the determination bitmap, decide the processing content for the data based on the information regarding the data content, and detect abnormal data. In this case, since the gateway device performs part of the processing that is performed normally by the ECU, it is possible to reduce the processing load on the ECU.

There are various methods of deriving an index other than the division in the above embodiment. Three or more indices may be derived, and the processing content for data may be decided with reference to a three-dimensional determination bitmap.

Other than CAN, the in-vehicle network may be Ethernet (Registered trademark of Fuji Xerox), FD, or the like, and may be anything using a data ID.

<Flow of Operation of Deciding Data Processing Content>

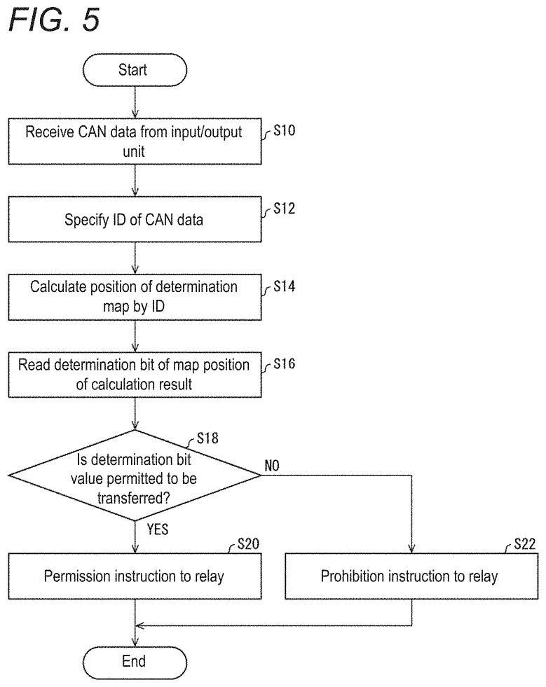

Next, the flow of the operation of deciding the processing content for the in-vehicle network (CAN) data executed by the gateway device 10 of the embodiment will be described with reference to FIG. 5. FIG. 5 is a flowchart of the processing of deciding the processing content for the in-vehicle network (CAN) data executed by the gateway device 10 of the embodiment.

(Step S10)

In step S10, the input/output unit 1010 of the gateway device 10 receives data from another in-vehicle device or the like. Subsequently, the process proceeds to step S12.

(Step S12)

In step S12, the data ID of the CAN data received by the ID acquisitor 1021 is specified. Subsequently, the process proceeds to step S14.

(Step S14)

In step S14, the decider 1022 of the security manager 1020 calculates the bit position in the determination bitmap 1030 based on the acquired data ID. As described above, the calculation method may be a method of dividing the data ID by a specific constant and acquiring a quotient and a remainder. Subsequently, the process proceeds to step S16.

(Step S16)

In step S16, the decider 1022 of the security manager 1020 reads the determination bit of the position in the determination bitmap specified in step S14 based on the calculation result. Subsequently, the process proceeds to step S18.

(Step S18)

In step S18, the decider 1022 judges whether or not data transfer is permitted from the determination bit read in step S16. If it is determined that data transfer is permitted (YES in step S18), the process proceeds to step S20. If it is determined that data transfer is not permitted (NO in step S18), the process proceeds to step S22.

(Step S20)

In step S20, the decider 1022 issues an instruction for the relay 1023 to permit data transfer. The relay 1023 transfers CAN data via a predetermined channel according to the instruction.

(Step S22)

In step S22, the decider 1022 issues an instruction for the relay 1023 to prohibit data transfer. The relay 1023 does not transfer the CAN data and discards it according to the instruction.

Thus, the processing of deciding the processing content for the data of the CAN data communication executed by the gateway device 10 of the embodiment ends.

According to the above-described processing, it is possible to prevent the processing time from increasing and to quickly perform the processing of deciding the processing content for the data of the in-vehicle network (CAN) communication. As a result, it is possible to shorten the transfer time of the data received from the in-vehicle network (CAN). As a result, it is possible to prevent the amount of data communication from decreasing, and to realize a network that is less susceptible to DOS attacks.

### Second Embodiment

Another embodiment of the present invention will be described below. For convenience of explanation, members having the same functions as those described in the above embodiment are given the same reference numerals, and the description thereof is not repeated.

<Configuration of Gateway Device 10>

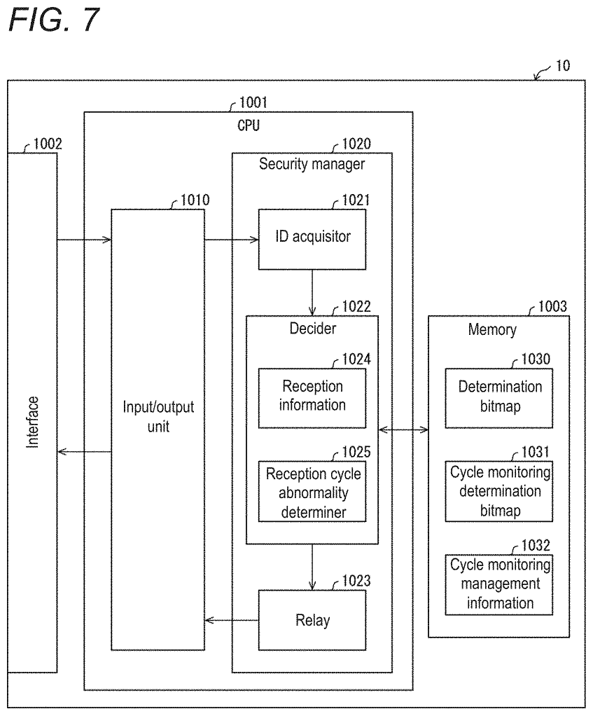

First, a configuration example of a gateway device 10 according to the second embodiment will be described with reference to FIG. 7. FIG. 7 is a block diagram showing an example of the functional configuration of the gateway device 10 according to the second embodiment. As shown in FIG. 7, the gateway device 10 of the second embodiment has basically the same configuration as that of the gateway device 10 of the first embodiment, and therefore only the differences from the gateway device 10 of the first embodiment will be described below.

As shown in FIG. 7, a decider 1022 in the second embodiment includes a reception time information recorder 1024 and a reception cycle abnormality determiner 1025.

The reception time information recorder 1024 records, in a memory 1003, reception time information indicating the time of receiving data. For example, in a case where the information stored in a reference destination of the table (cycle monitoring determination bitmap) specified using the data ID associated with received data indicates the necessity of cycle monitoring for the data, the reception time information recorder 1024 stores, in the memory 1003, the reception time information of the received data as cycle monitoring management information 1032. The cycle monitoring management information 1032 will be described later.

When the necessity of cycle monitoring for the data is indicated, the reception cycle abnormality determiner 1025 determines the presence or absence of an abnormality in the reception cycle of the data based on past reception time information and current reception time information recorded in the memory 1003 by the reception time information recorder 1024. The determination of the presence or absence of an abnormality in the reception cycle of the data will be described later.

The decider 1022 decides whether or not to transfer the data to the relay 1023 based on the determination made by the reception cycle abnormality determiner 1025.

The memory 1003 stores, in addition to the determination bitmap 1030 stored in the memory 1003 according to the first embodiment, a cycle monitoring determination bitmap 1031 and cycle monitoring management information 1032, as an example.

Since the configuration other than the above is the same as that of the gateway device 10 in the first embodiment shown in FIG. 2, the description is omitted here.

<Example of Reception Cycle Monitoring Determination Bitmap>

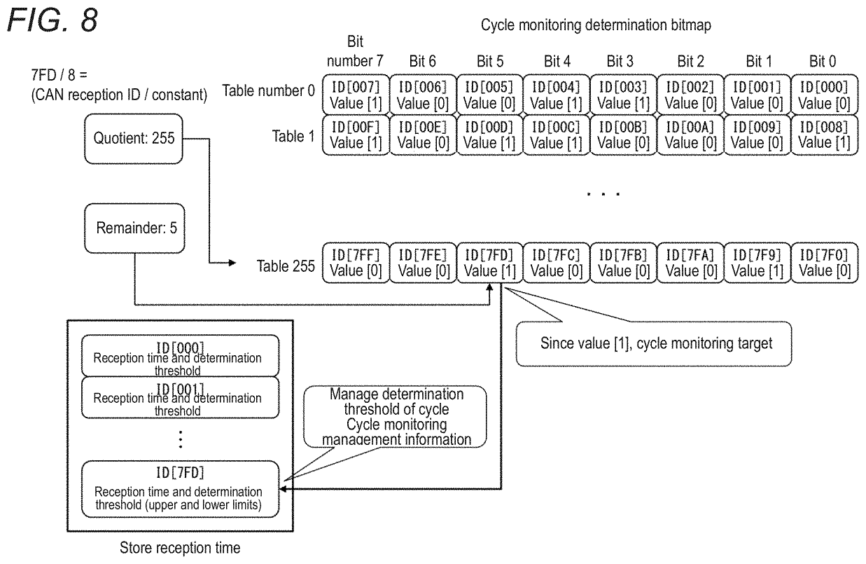

Next, a cycle monitoring determination bitmap used when determining an abnormality of a reception cycle will be described with reference to FIG. 8. Similar to the determination bitmap table shown in FIG. 4, the cycle monitoring determination bitmap shown in FIG. 8 is a table including 8 columns in the horizontal direction from bit number 0 to bit number 7 and 256 rows in the vertical direction from table number 0 to table number 255 and storing a total of 2048 data IDs together with information as to whether or not the data associated with each data ID is a cycle monitoring target. In each position of the period determination bitmap, it is shown whether or not data associated with each data ID is cycle monitoring target data. For example, a value [1] is stored when the data is a cycle monitoring target, and a value [0] is stored when the data is not a cycle monitoring target. Alternatively, the value [0] may be stored when the data is a cycle monitoring target, and the value [1] may be stored when the data is not a cycle monitoring target.

In the gateway device 10 of the second embodiment, the decider 1022 derives a plurality of indices from the data ID, specifies a reference destination from the plurality of derived indices, and decides whether or not the data associated with the data ID is a cycle monitoring target based on information stored in the specified reference destination.

For example, the decider 1022 may set the quotient and the remainder obtained by dividing the data ID as the first index and the second index, respectively.

The derivation of the index and the decision of whether or not the data based on the derived index is a cycle monitoring target will be described in detail below with reference to the cycle monitoring determination bitmap 1031 shown in FIG. 8.

In the embodiment, the decider 1022 divides the received CAN data ID by a certain constant (e.g., 8). The quotient obtained as a result of division is set as a first index and the remainder obtained as a result of division is set as a second index.

As an example, assume that as a result of dividing the CAN data ID: 7FD by a constant 8, a quotient 255 and a remainder 5 are obtained. With reference to the quotient 255, which is the first index, the decider 1022 specifies the table of the table number 255 from a plurality of tables (table number 0 to table number 255) included in the determination bitmap 1030 shown in FIG. 8. With reference to the remainder 5, which is the second index, the decider 1022 specifies the bit of the bit number 5 from the table of the table number 255.

Thus, the position in the determination bitmap 1030 corresponding to the CAN data ID: 7FD in the determination bitmap 1030, i.e., the position of the table number 255 and the bit number 5 is specified. The value [1] is stored in the specified position. Therefore, the decider 1022 can determine that the data corresponding to the CAN data ID: 7FD is a cycle monitoring target. In this case, as schematically shown in FIG. 8, the reception time information recorder 1024 stores the reception time of data in the cycle monitoring management information 1032 of the memory 1003.

When the value [0] is stored in the specified position, the decider 1022 determines that the data is not a cycle monitoring target. In this case, the decider 1022 instructs transfer of the data to the relay 1023.

The embodiment may have a configuration in which, as an example, the decider 1022 determines whether or not to transfer data with reference to the determination bitmap 1030, further refer to the cycle monitoring determination bitmap 1031 in accordance with the determination result, and determines whether or not the data is a cycle monitoring target. In a case of such a configuration, upon receiving data from the in-vehicle network, the decider 1022 first refers to the determination bitmap 1030 shown in FIG. 3 or FIG. 4 to decide whether or not to transfer the data. Next, the decider 1022 decides whether or not the data is a cycle monitoring target with reference to the cycle monitoring determination bitmap 1031 shown in FIG. 8. If the decider 1022 determines that the data is a cycle monitoring target, as shown in the cycle monitoring management information shown in the lower left of FIG. 8, the reception time information recorder 1024 repeats storing the reception time of the data.

Furthermore, the reception cycle abnormality determiner 1025 determines whether or not the reception cycle of the data determined to be the cycle monitoring target is within a predetermined threshold value range based on the cycle monitoring management information. The decider 1022 decides the processing content for the data based on the determination result. This will be described later.

<Flow of Data Processing>

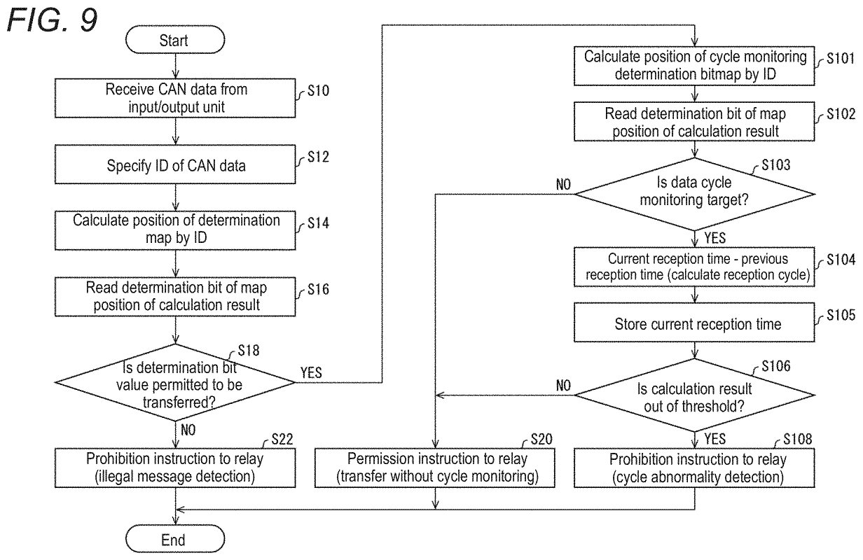

In the following, the flow of processing in the gateway device 10 will be described more specifically with reference to FIG. 9.

The processing in steps S10 to S16 in the flowchart of FIG. 9 are the same as those in the first embodiment, and the description thereof will not be repeated.

(Step S18)

In step S18, the decider 1022 judges whether or not data transfer is permitted from the determination bit read in step S16. If it is determined that data transfer is permitted (YES in step S18), the process proceeds to step S101. If it is determined that data transfer is not permitted (NO in step S18), the process proceeds to step S22.

(Step S101)

In step S101, the decider 1022 calculates the position of the reference destination in the cycle monitoring determination bitmap 1031 from the data ID, and the process proceeds to step S102. Specific processing of the reference destination in this step is as described above.

(Step S102)

In step S102, the reference destination determination bit indicated by the calculation result in step S101 is read. Thereafter, the process proceeds to step S103.

(Step S103)

In step S103, the decider 1022 decides whether or not the data is a cycle monitoring target based on the value of the determination bit read in step S102. If the decider 1022 decides in step S103 that the data is not a cycle monitoring target, the process proceeds to step S20, and the transfer of the data to the relay 1023 is instructed without monitoring the reception cycle. If the decider 1022 decides in step S103 that the data is a cycle monitoring target, the process proceeds to step S104.

(Step S104)

In step S104, the reception cycle abnormality determiner 1025 reads the reception time of the previous data from the cycle monitoring management information 1032, and then calculates a reception cycle by subtracting the reception time of the previous data from the reception time of the current data, and the process proceeds to step S105. Here, the data reception time means, for example, the time at which the input/output unit 1010 of the gateway device 10 receives data from the in-vehicle network.

(Step S105)

In step S105, the reception time information recorder 1024 stores the current data reception time in the memory 1003, and the process proceeds to step S106. Note that the processing in step S104 and the processing in step S105 may be performed simultaneously or in reverse order.

(Step S106)

In step S106, the reception cycle abnormality determiner 1025 determines whether or not the reception cycle of the data is within a predetermined threshold range. Details of the determination processing in this step will be described later.

If it is determined in step S106 that the data reception cycle is within a predetermined threshold range (NO in step S106), the process proceeds to step S20, where the decider 1022 instructs transfer of the data to the relay 1023. It should be noted that the term “Within a range” used above includes a case of completely matching the range.

If the reception cycle abnormality determiner 1025 determines in step S106 that the reception cycle of the data is out of the range of the predetermined threshold (YES in step S106), the process proceeds to step S108, and the transfer of data to the relay 1023 is inhibited.

<Example of Cycle Monitoring Management Information>

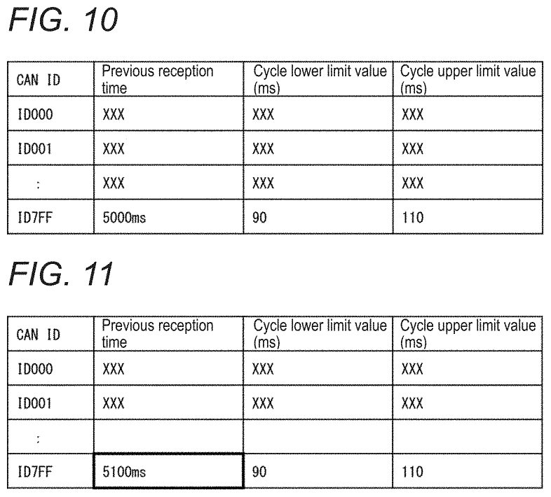

With reference to FIGS. 10 and 11, a description will be given regarding an example of the cycle monitoring management information used when performing determination processing as to whether or not the data received by the reception cycle abnormality determiner 1025 becomes a cycle monitoring target. In the embodiment, the reception time information recorder 1024 stores, into the memory 1003, reception time information indicating the time when the data is received, together with the data ID of the data.

Note that the reception time information recorder 1024 may store, in the memory 1003, the reception time of only the data for which the decider 1022 permits transfer and the data received by the reception cycle abnormality determiner 1025 is determined to be the cycle monitoring target, or may store, in the memory 1003, the reception time for all the received data.

For example, for data ID: ID7FF, as shown in the table of FIG. 10, the previous reception time is stored as 5000 ms (milliseconds), and the lower limit of the reception cycle is set to 90 ms and the upper limit thereof is set to 110 ms. When data is newly received currently, as shown in FIG. 11, the reception time information recorder 1024 updates the reception information.

When the reception time of the current data is, for example, 5100 ms, the reception cycle abnormality determiner 1025 calculates a reception cycle of 100 ms by taking a difference between the previous reception time and the present reception time. The reception cycle abnormality determiner 1025 determines that the value of the reception cycle is within the range of the reception cycle set in advance (90 ms or more and 110 ms or less). Therefore, the reception cycle abnormality determiner 1025 determines that the reception cycle of the data has no abnormality, and the decider 1022 instructs transfer to the relay 1023. If the reception cycle abnormality determiner 1025 determines that the value of the reception cycle is out of the range of the reception cycle set in advance (less than 90 ms or greater than 110 ms), it determines that the reception cycle of the data has an abnormality, and the decider 1022 prohibits transfer to the relay 1023.

As described above, in the embodiment, since the reception cycle abnormality determiner 1025 determines the presence or absence of an abnormality in the reception cycle, it is possible to ensure the safety of the in-vehicle network. In the embodiment, as an example, with regard to the data determined to be transferable with reference to the determination bitmap 1030 by the decider 1022, it is further determined whether or not the data is a cycle monitoring target with reference to the cycle monitoring determination bitmap 1031. Then, with regard to the data determined to be the reception cycle monitoring target by the decider 1022, the reception cycle abnormality determiner 1025 determines the presence or absence of an abnormality in the reception cycle. This can further ensure the safety of the in-vehicle network.

[Implementation Example by Software]

The control block (in particular, the security manager 1020) of the gateway device 10 may be implemented by a logic circuit (hardware) formed in an integrated circuit (IC chip) or the like, or may be implemented by software.

In the latter case, the gateway device 10 includes a computer that executes a command of a program that is software implementing each function. This computer includes, for example, one or more processors and a computer-readable recording medium storing the program. In the computer, the processor reads and executes the program from the recording medium, thereby achieving the object of the present invention. As the processor, for example, a central processing unit (CPU) can be used. As the recording medium described above, a “non-temporary tangible medium”, for example, a read only memory (ROM), a tape, a disk, a card, a semiconductor memory, a programmable logic circuit, or the like can be used. A random access memory (RAM) that expands the program may be further provided. The program described above may be supplied to the computer via any transmission medium (communication network, broadcast wave, and the like) capable of transmitting the program. It should be noted that an aspect of the present invention can also be implemented in the form of a data signal embedded in a carrier wave in which the program described above is embodied by electronic transmission.

The present invention is not limited to the embodiments described above, and various modifications can be made within the scope of the claims, and the embodiments obtained by appropriately combining the technical means disclosed in the different embodiments are also within the scope of the present invention.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A gateway device comprising:
a controller and a storage,
wherein the controller includes
an ID acquisitor configured to acquire a data ID associated with data to be received from an in-vehicle network, and
a decider configured to derive a plurality of indices from the data ID, specify a reference destination in a reference table stored in the storage based on a plurality of derived indices, and decide a processing content related to data associated with the data ID based on information stored in a specified reference destination.

2. The gateway device according to claim 1, wherein the decider decides whether or not to transfer data associated with the data ID based on information stored in the specified reference destination.

3. The gateway device according to claim 2, wherein the decider decides a data length of data associated with the data ID based on information stored in the specified reference destination, and decides whether or not to transfer the data according to the decided data length.

4. The gateway device according to claim 1,
wherein the decider derives at least a first index and a second index as the plurality of indices,
wherein the decider specifies any of a plurality of tables included in the reference table based on the first index, and
wherein the decider specifies one or a plurality of values indicated by the second index from each value stored in a specified table, and decides a processing content to be executed based on a specified value.

5. The gateway device according to claim 4, wherein the decider sets a quotient and a remainder obtained by dividing the data ID by a predetermined constant as the first index and the second index, respectively.

6. The gateway device according to claim 5, wherein the predetermined constant matches an address allocation unit in the storage.

7. The gateway device according to claim 1,
wherein the decider includes
a reception time information recorder configured to record reception time information indicating a time at which data is received, and
a reception cycle abnormality determiner, and
wherein if information stored in a reference destination specified using a data ID associated with received data indicates necessity of cycle monitoring for the data, the reception time information recorder records reception time information of the data having been received, and
wherein the reception cycle abnormality determiner determines presence or absence of an abnormality of reception cycle of the data based on past reception time information and current reception time information recorded by the reception time information recorder.

8. A non-transitory computer-readable medium storing a data structure of data referred to by an in-vehicle gateway device, the data structure comprising:
a plurality of tables storing each value indicating a processing content,
wherein the gateway device derives a plurality of indices including a first index and a second index from a data ID associated with the data,
wherein the gateway device specifies any of the plurality of tables based on the first index, and
wherein the gateway device specifies a value indicated by the second index from each value stored in a specified table, and decides a processing content to be executed based on a specified value.
